(19) United States
(12) Patent Application Publication
(10) Pub. No.: US 2012/0325585 A1
(43) Pub. Date: Dec. 27, 2012

(54) Reflective Friction-Enhancement For Surfaces

(75) Inventors: Dale Glenn Cox, El Reno, OK (US); John Cunningham, McKinney, TX (US)

(73) Assignee: Trans-Tech LLC, El Reno, OK (US)

(21) Appl. No.: 13/168,416

(22) Filed: Jun. 24, 2011

(51) Int. Cl. E06C 7/16; B61D 49/00; B61C 17/00; E06C 7/08; B32B 37/02; B32B 5/16

(52) U.S. Cl. 182/228.2; 156/182; 428/143; 428/147; 182/222; 105/425

(57) ABSTRACT

A modular safety unit for application to surfaces requiring reflectivity and friction. The unit has a front surface with a high-reflectivity portion and a roughening agent. The high reflectivity portion and roughening agent can be connate or separate. The unit also has a back surface which may be applied to a platform surface such as a rail car step, ladder rung or walkway. The back surface of the unit comprises an adhesive, or may itself be adhered to a surface.

### FIELD OF THE INVENTION

The present invention relates to the field of reflective and frictional features.

### SUMMARY OF THE INVENTION

The present invention comprises a modular safety unit. The safety unit comprises a front surface and a back surface disposed opposite the front surface. The front surface comprises a high reflection portion and a roughening agent. The back surface comprises an adhesive.

The present invention is further directed to a reflective safety platform assembly. The assembly comprises a platform surface and a modular safety unit. The modular safety unit is adherable to the platform surface. The modular safety unit comprises a high reflection portion and a roughening agent disposed proximate the high reflection portion.

In another embodiment the invention is directed to a method for improving safety on a rail car. The method comprises providing a modular safety unit, adhering the safety unit to the rail car, and using the safety unit to move personnel about the rail car. The safety unit comprises a first surface comprising a high reflection portion and a roughening agent. The high reflection portion and roughening agent are directed outward.

### BRIEF DESCRIPTION OF THE DRAWINGS

FIG. 1 is a top view of a modular safety unit assembly.

FIG. 2 is a top view of a friction-enhancing assembly having a connate roughening agent and reflective portion.

FIG. 3 is a top view of a safety unit applied to a platform surface comprising a railcar step.

FIG. 4 is a top perspective view of a safety unit applied to a platform surface comprising a ladder rung.

### DETAILED DESCRIPTION OF THE PREFERRED EMBODIMENTS

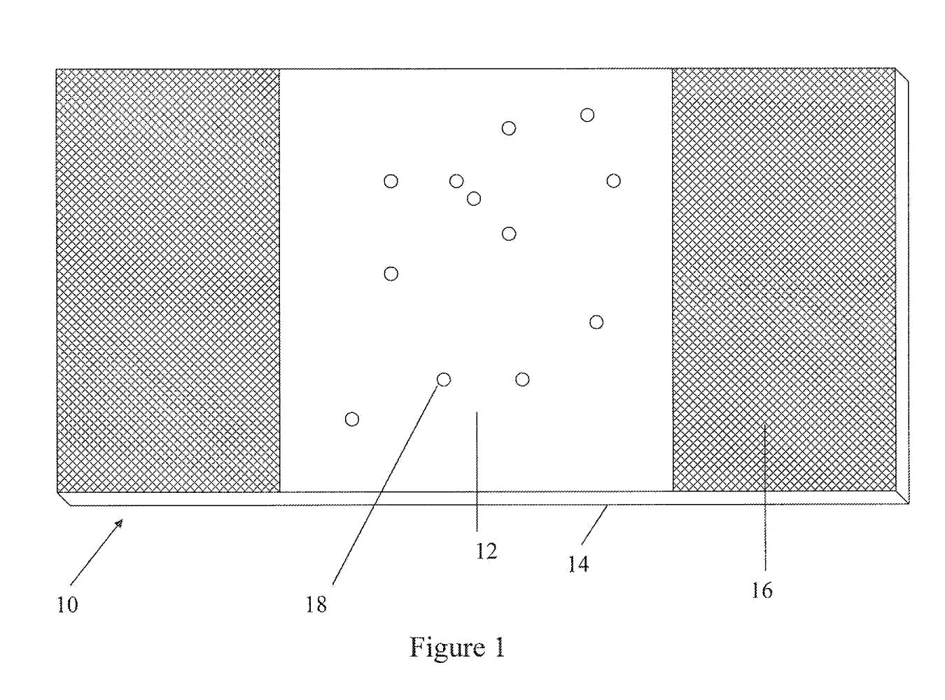

Regulated industries, such as railroads, require highly reflective markers of a particular strength and durability to be placed on rail cars and their features. With reference to the figures in general, and to FIG. 1 in particular, shown therein is a modular safety unit 10. The safety unit 10 is thin and geometrically shaped. The safety unit 10 is preferably rectangular. Alternatively, the safety unit 10 may be another shape, such as square or triangular. In any embodiment, a length and width of the safety unit 10 is substantially greater than the thickness. The safety unit 10 comprises a front surface 12 and an opposed back surface 14, each having substantially the same length and width as the safety unit.

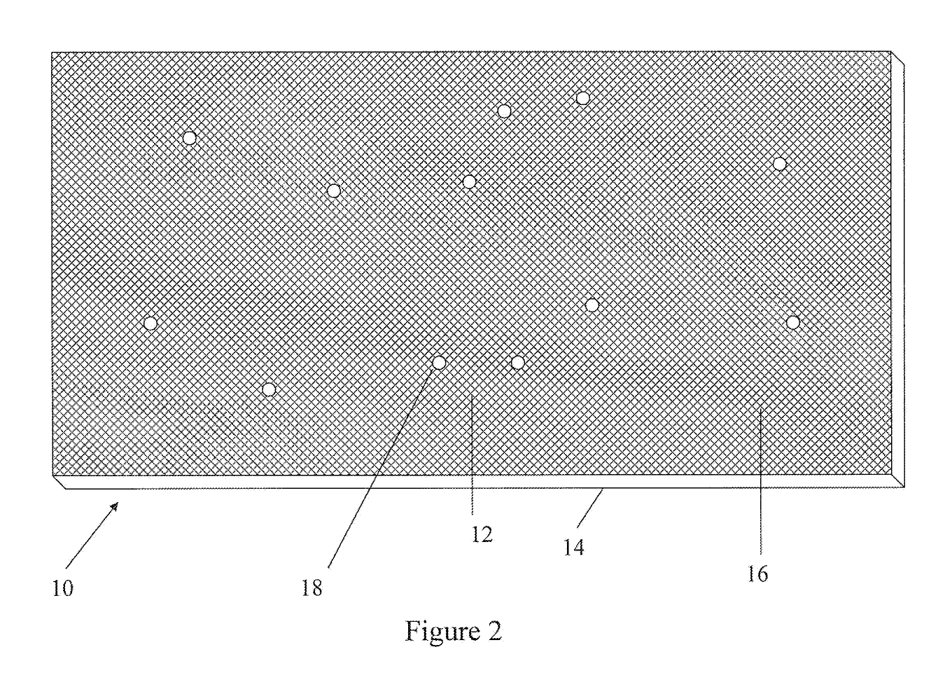

The front surface 12 comprises a high-reflection portion 16 and a roughening agent 18. The high-reflection portion 16 is adapted to reflect light. Preferably, the high-reflection portion 16 is of a nature that reflects light striking the front surface 12 from a plurality of angles. The high-reflection portion 16 may be a color to correspond to a certain industry or signal, such as yellow or red, as the application of the safety unit 10 requires. The high-reflection portion 16 may comprise a geometric pattern or a metallic surface to accomplish the reflective function of the front surface 12. As shown in FIG. 1, the high-reflection portion 16 is disposed about a portion of the front surface 12. With reference to FIG. 2, the high-reflection portion 16 is disposed about the entirety of the front surface 12.

As shown in FIGS. 1 and 2, the roughening agent 18 is disposed on the front surface 12. The embodiment of FIG. 1 shows the roughening agent 18 separated from the high-reflection portion 16 to avoid obscuring the high-reflection portion. FIG. 2 shows the high reflection portion 16 and roughening agent 18 connate on the front surface 12. A connate orientation may be preferable to increase the area of high friction and reflection on the front surface 12.

The roughening agent 18 may be a resin or other aggregate solid placed upon or into the front surface 12. Alternatively, the front surface 12 may be scoured or roughened such that an element of the front surface 12 is the roughening agent 18.

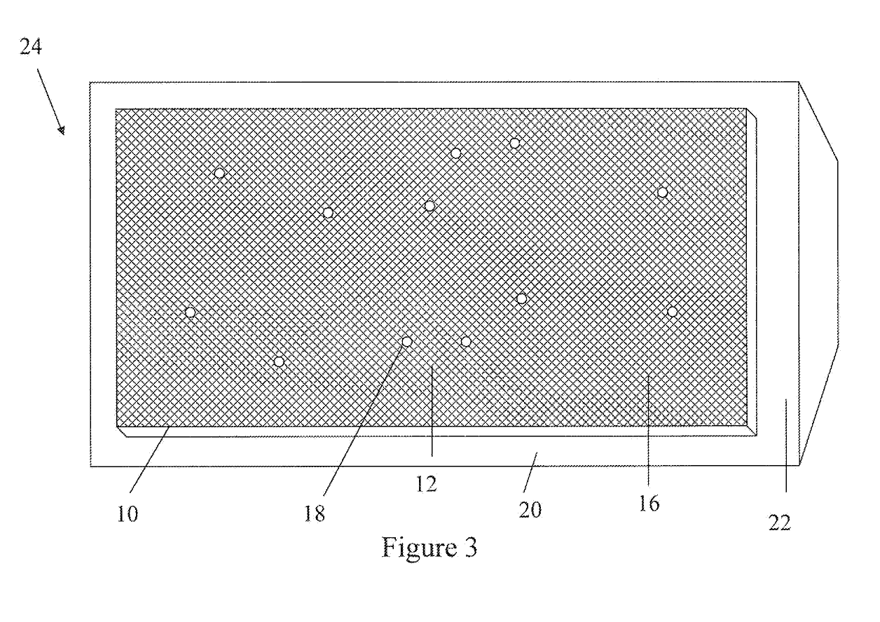

With continued reference to FIGS. 1 and 2, the back surface 14 is adhesive in nature. The back surface 14 may be covered with adhesive glue for attachment to another surface. Alternatively, the back surface 14 may be adhesive by its nature, such as in the case of a powder coating or other applied unit. Further, the unit 10 may be heated to cause the back surface 14 to become adhesive, then cooled to adhere the unit to a platform surface 20 (FIG. 3).

With reference now to FIG. 3, the safety unit 10 is located on a platform surface 20. As shown in FIG. 3, the platform surface 20 comprises a rail car step 22. The rail car step 22 is preferably completely covered with the safety unit 10 such that the surfaces of the rail car step that are likely to be contacted by an operator are completely covered by the front surface 12 of the safety unit. Specifically, the high-reflection portion 16 should be visible and the roughening agent 18 accessible to those contacting the safety unit 10 by accessing the rail car step 22. When placed on a platform surface 20, the safety unit 10 and platform surface form a reflective safety platform assembly 24.

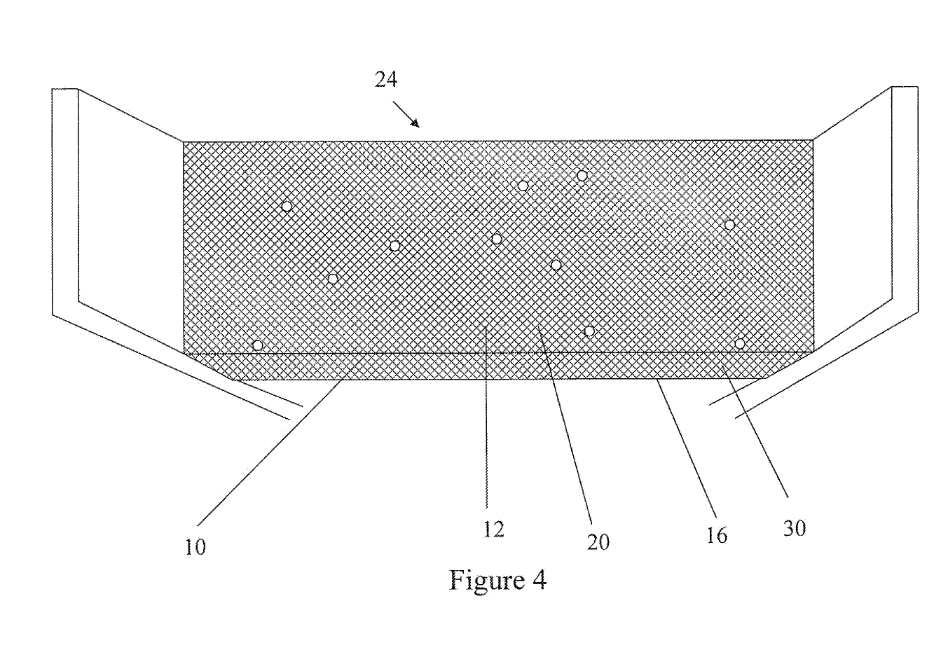

With reference now to FIG. 4, shown therein is a reflective safety platform assembly 24 where the platform surface 20 comprises a ladder rung 30. The front surface 12 of the safety unit 10 preferably covers the whole surface of the ladder rung 30.

A handhold 30 and rail car step 22 are two alternative embodiments of the platform surface 20 which may be utilized. However, this should not be viewed as limiting the platform surfaces 20 to which the safety unit 10 can be applied. For example, the platform surface may comprise a walkway, stair, or any other platform surface which may require friction and high reflection.

In operation, the reflective safety platform assembly 24 can be used to provide a method for improving safety on a platform surface 20 or a feature which has multiple platform surfaces. One embodiment features the safety unit 10 on a platform surface 20 which is located proximate a rail car. The method comprises providing the modular safety unit 10 and adhering the safety unit 10 to the platform surface 20 using the adhesive of the back surface 14. The front surface 12 is directed outward so that the high reflection portion 16 may be seen and the roughening agent 18 may be contacted. The safety unit 10 may then be used to move personnel about the rail car or other location with greater reflectivity and friction. Preferably, a plurality of safety units 10 are used. The high reflection portion 16 may be formed by adding a reflective substance to the front surface 14 before or after application of the unit 10 to the platform surface 20. Likewise, the roughening agent 18 may be added before or after application of the unit 10 to the platform surface 20.

Various modifications can be made from the design and operation of the present invention without departing from its spirit. Thus, while the principal preferred construction and modes of operation of the invention have been explained in what is now considered to represent its best embodiments, it should be understood that within the scope of the appended claims, the invention may be practiced otherwise than as specifically illustrated and described.

What is claimed is:

1. A modular safety unit comprising:
a front surface, the front surface comprising a high reflection portion and a roughening agent; and
a back surface disposed opposite the front surface comprising an adhesive.

2. The unit of claim 1 wherein the high reflection portion and roughening agent are connate on the front surface.

3. The unit of claim 1 wherein the unit is adapted to adhere to a platform surface.

4. The unit of claim 3 wherein the platform surface comprises a rail car step.

5. The unit of claim 1 wherein the roughening agent comprises resin substantially evenly distributed about the front surface.

6. The unit of claim 1 wherein the high reflection portion comprises a geometric pattern substantially evenly distributed about the front surface.

7. The unit of claim 6 wherein the roughening agent comprises a resin substantially evenly distributed about the front surface.

8. A reflective safety platform assembly comprising:
a platform surface; and
a modular safety unit conforming and adherable to the platform surface, the modular safety unit comprising:
a high reflection portion; and
a roughening agent disposed proximate the high reflection portion.

9. The assembly of claim 8 wherein the platform comprises a step.

10. The assembly of claim 8 wherein the platform comprises a ladder rung.

11. The assembly of claim 8 wherein the platform comprises a walkway.

12. The assembly of claim 8 further comprising a rail car, wherein a portion of the rail car comprises the platform.

13. The assembly of claim 8 wherein the high reflection portion comprises a metallic geometric pattern.

14. The assembly of claim 8 wherein the roughening agent comprises resin.

15. The assembly of claim 8 wherein the high reflection portion is connate to the roughening agent.

16. The assembly of claim 8 wherein the roughening agent and the high reflection portion are connate.

17. The assembly of claim 8 further comprising an adhesive.

18. A method for improving safety on a rail car comprising:
providing a modular safety unit comprising a front surface having a high reflection portion and a roughening agent;
adhering the safety unit to the rail car with the high reflection portion and roughening agent directed outward; and
using the safety unit to move personnel about the rail car.

19. The method of claim 18 wherein the high reflection portion is connate to the roughening agent.

20. The method of claim 18 further comprising placing a plurality of modular safety units on the rail car.

21. The method of claim 18 wherein the safety unit is adhered to the rail car at a ladder rung.

22. The method of claim 18 further comprising adding a reflective substance to the front surface to form the high reflection portion.

23. The method of claim 18 further comprising adding the roughening agent to the front surface such that the roughening agent and high reflection portion are evenly distributed about the safety unit.
